(19) United States
(12) Patent Application Publication
(10) Pub. No.: US 2022/0122175 A1
(43) Pub. Date: Apr. 21, 2022

(54) Exchange Rate Management System and Game System

(71) Applicant: Universal Entertainment Corporation, Koto-ku, Tokyo (JP)

(72) Inventor: Jun HAISHIMA, Koto-ku, Tokyo (JP)

(21) Appl. No.: 17/428,074

(22) PCT Filed: Feb. 7, 2020
(86) PCT No.: PCT/JP2020/004734

§ 371 Date: Aug. 3, 2021

(30) Foreign Application Priority Data
Feb. 12, 2019 (JP) 2019-022871

(51) Int. Cl. G06Q 40/04; G07F 17/32

(52) U.S. Cl. CPC G06Q 40/04; G07F 17/3246; G07F 17/3223

(57) ABSTRACT

Even when exchange is performed at a wrong exchange rate, the wrong state is easily corrected to a state in which the exchange is performed at a correct exchange rate. An exchange rate management system P1 of an embodiment includes processing units P2 in which game play is possible with a value in an available currency exchanged from a value in an unavailable currency at an exchange rate, a main storage device A312 configured to store an exchange rate updated at a predetermined timing, a sub storage device A21 which is provided in each processing unit P2 to store an exchange rate, and a relay storage device A322 configured to store an exchange rate which is to be deployed in the sub storage device A21, in a manner of being updatable to the exchange rate stored in the main storage device A312. The main storage device A312, the sub storage device A21, and the relay storage device A322 include update time storage units A3121, A211, and A3221 storing a time when the exchange rate is updated, respectively.

### TECHNICAL FIELD

The present invention relates to an exchange rate management system which supports plural currencies.

### BACKGROUND ART

A known game system (see PTL 1) is arranged such that, after an exchange rate is obtained from the outside (the internet) through a communication line and stored in an exchange server, the exchange rate is sent from the exchange server to slot machines, and exchange to a local currency is performed at each slot machine based on money type data, monetary amount data, and the exchange rate, and hence values of different currencies can be exchanged to a value of a predetermined currency at the exchange rate and can be used at each slot machine. Some facilities provided with such slot machines are large-scale facilities with 1000 or more slot machines.

### CITATION LIST

### Patent Literatures

[PTL 1] U.S. Pat. No. 9,646,446

### SUMMARY OF INVENTION

### Technical Problem

The above-described known arrangement is advantageous in that plural currencies can be used in each slot machine. However, for example, when a large number of slot machines are provided in a large-scape facility, even a partial communication failure makes it difficult to verify which slot machine performed exchange at a correctly-updated exchange rate.

The present invention has been made in view of the above. An object of the present invention is to easily verify an update state of an exchange rate even when there are a large number of gaming machines.

### Solution to Problem

An exchange rate management system of the present invention includes processing units that are capable of converting a value in an unavailable currency to a value in an available currency at an exchange rate and processing the value, the exchange rate management system comprising: a main storage device configured to store the exchange rate which is updated at a predetermined timing;
a sub storage device which is provided in each of the processing units to store the exchange rate; and
a relay storage device configured to store an exchange rate to be deployed in the sub storage device, in a manner of being updatable to the exchange rate stored in the main storage device, each of the main storage device, the sub storage device, and the relay storage device including an update time storage unit configured to record a time when the exchange rate is updated.

According to the arrangement above, because an update time of the exchange rate is stored in all of the main storage device, the sub storage device, and the relay storage device, it is possible to easily check the update state of the exchange rate in each of the storage devices based on the update time and the exchange rate. In other words, in the arrangement described above, the update state of the exchange rate is easily verified even if there are a large number of processing units.

In the exchange rate management system of the present invention, furthermore, each of the sub storage device and the relay storage device further includes a use time storage device configured to record a time when the unavailable currency is used.

According to this arrangement, as the sub storage device and the relay storage device check and compare states of an execution result of a process of exchange to a value in the available currency based on an exchange rate at an update time and the unavailable currency at a use time, it is possible to easily determine whether the execution result of the process is appropriate.

The exchange rate management system of the present invention further includes a main update device including an input device accepting an input from an operator in order to update an exchange rate stored in the main storage device, a relay update device including an input device accepting an input from an operator in order to update an exchange rate stored in the relay storage device, and a deployment device including an input device accepting an input from an operator in order to deploy, in the sub storage device, an exchange rate stored in the relay storage device.

With this arrangement, it is possible to update a stored exchange rate and deploy the exchange rate in each processing unit, under visual control from the outside by which massive falsification of the exchange rate in a short time is prevented.

A game system of the present invention includes gaming machines in which a game is playable by converting a value in an unavailable currency to a value in an available currency at an exchange rate, the game system comprising:
a main storage device configured to store the exchange rate which is updated at a predetermined timing;
a sub storage device which is provided in each of the gaming machines to store the exchange rate; and
a relay storage device configured to store an exchange rate to be deployed in the sub storage device, in a manner of being updatable to the exchange rate stored in the main storage device, each of the main storage device, the sub storage device, and the relay storage device including an update time storage unit configured to record a time when the exchange rate is updated.

According to the arrangement above, because an update time of the exchange rate is stored in all of the main storage device, the sub storage device, and the relay storage device, it is possible to easily check the update state of the exchange rate in each of the storage devices based on the update time and the exchange rate. In other words, in the arrangement described above, the update state of the exchange rate is easily verified even if there are a large number of gaming machines.

A game system of the present invention includes gaming machines in which a game is playable by converting a value in an unavailable currency to a value in an available currency at an exchange rate, the game system comprising:
a main storage device configured to store the exchange rate which is updated at a predetermined timing;
a sub storage device which is provided in each of the gaming machines to store an exchange rate that is referred to each time the unavailable currency is used in one of the gaming machines; and
a relay storage device configured to store an exchange rate to be deployed in the sub storage device, in a manner of being updatable to the exchange rate stored in the main storage device, each of the main storage device, the sub storage device, and the relay storage device including an update time storage unit configured to record a time when the exchange rate is updated.

According to the arrangement above, because an update time of the exchange rate is stored in all of the main storage device, the sub storage device, and the relay storage device, it is possible to easily check the update state of the exchange rate in each of the storage devices based on the update time and the exchange rate. In other words, in the arrangement described above, the update state of the exchange rate is easily verified even if there are a large number of gaming machines.

### Advantageous Effects

The present invention makes it possible to easily verify an update state of an exchange rate.

### BRIEF DESCRIPTION OF DRAWINGS

FIG. 1 illustrates the outline of an exchange rate management system.

FIG. 2 is a block diagram of a game system.

FIG. 3 illustrates how the game system works.

FIG. 4 is a block diagram of a slot machine.

FIG. 5 is a flow chart showing steps of updating an exchange rate.

FIG. 6 is a flow chart showing how a casino system works.

### DESCRIPTION OF EMBODIMENTS

(Outline of Exchange Rate Management System)

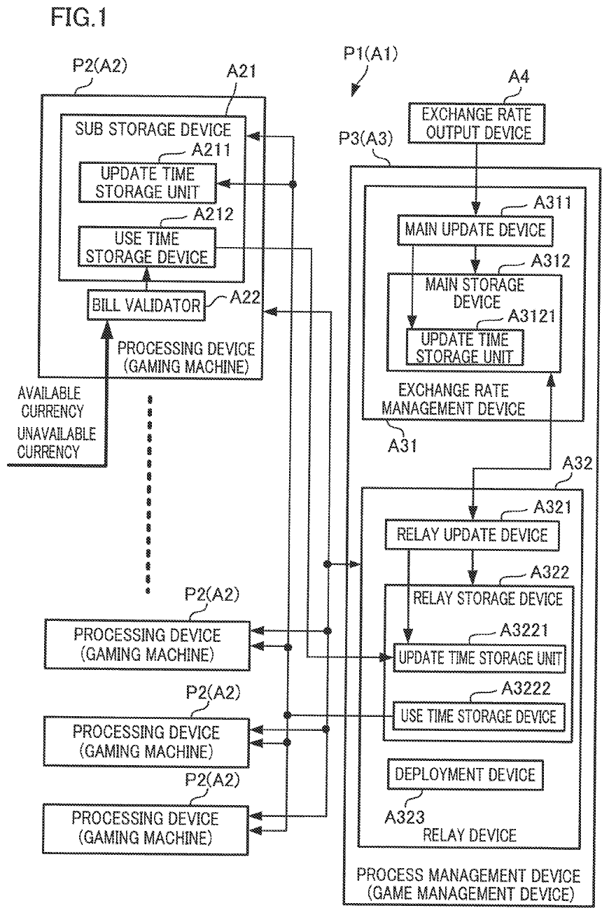

As shown in FIG. 1, an exchange rate management system P1 of an embodiment includes processing units P2 in which game play is possible with a value in an available currency exchanged from a value in an unavailable currency at an exchange rate, a main storage device A312 configured to store an exchange rate updated at a predetermined timing, a sub storage device A21 which is provided in each processing unit P2 to store an exchange rate, and a relay storage device A322 configured to store an exchange rate which is to be deployed in the sub storage device A21, in a manner of being updatable to the exchange rate stored in the main storage device A312. The main storage device A312, the sub storage device A21, and the relay storage device A322 include update time storage units A3121, A211, and A3221 each of which stores a time when an exchange rate is updated.

Each time a processing unit P2 uses the unavailable currency, the exchange rate stored in the main storage device A312 may be referred to for the purpose of exchange to a value in the available currency, or the exchange rate stored in the sub storage device A21 may be referred to for the purpose of exchange to a value in the available currency. The following description deals with a case where an exchange rate stored in the main storage device A312 is referred to each time an unavailable currency is used in a processing unit P2.

In the exchange rate management system P1 arranged as described above, because an update time of the exchange rate is stored in all of the main storage device A312, the sub storage device A21, and the relay storage device A322, it is possible to easily check the update state of the exchange rate in each of the storage devices A312, A21, and A322 based on the update time and the exchange rate. In other words, in the exchange rate management system P1 described above, the update state of the exchange rate is easily verified even if there are a large number of processing units P2. On this account, even when exchange is performed at a wrong exchange rate, it is possible to easily correct the wrong state to a state in which the exchange is performed at a correct exchange rate.

In connection with the above, the exchange rate management system P1 can be provided in gaming facilities such as casinos. Furthermore, the exchange rate management system P1 can be provided in gaming facilities and facilities with processing units such as hotels, airports, stations, shopping malls, fuel supply stations capable of supply fuels such as gasoline, restaurants, and movie theaters, and in composite facilities in which different types of facilities are gathered. The processing unit P2 is a device executing various types of processes in exchange for user's consumption of money. Examples of the processing unit include gaming machines, vending machines, and ticket machines. The exchange rate management system P1 may include plural processing units P2 executing a process of the same type, or may include processing units P2 executing processes of different types. For example, the exchange rate management system P1 may include 1000 gaming machines, 100 ticket machines, and plural processing units P2.

The available currency is a currency that can be used in the exchange rate management system P1 without needing exchange at an exchange rate. The unavailable currency is a currency that needs to be exchanged to the available currency at an exchange rate. The exchange rate is output from an exchange rate output device A4 provided by, for example, a bank, and an operator is able to visually recognize the exchange rate.

The relationship between an available currency and an unavailable currency is as follows: when U.S. Dollar is an available currency among currencies such as U.S. Dollar, Hong Kong Dollar, Philippine Peso, and Japanese Yen, Hong Kong Dollar, Philippine Peso, and Japanese Yen are unavailable currencies. To be more specific, when U.S. Dollar is an available currency whereas Japanese Yen is an unavailable currency, a value in the unavailable currency (e.g., 100 Yen) and after-exchange currency value data indicating a value in the available currency (e.g., 1 Dollar) specified based on an exchange rate are sent to a controller of a processing unit P2. An exchange rate is set for each unavailable currency, and indicates the correspondence between a value in an available currency and a value in an unavailable currency (e.g., 1 Dollar=100 Yen). The exchange rate management system P1 is therefore able to perform various processes with different currencies such as U.S. Dollar and Japanese Yen. On this account, even after spending all money of an available currency (e.g., U.S. Dollar), the user is able to continue processes with money of another currency (e.g., Japanese Yen), without performing exchange.

Update at a predetermined timing indicates that, for example, in a weekday in which banks are open, update is performed at an exchange rate on that weekday at a timing during a predetermined period from 10 a.m. to 12 p.m., and in a holiday such as Saturday, Sunday, and a national holiday in which banks are closed, update is performed at an exchange rate on a weekday immediately after the holiday.

Deployment in the sub storage device A21 indicates that data is transmitted to each of the sub storage devices A21 of the processing units P2. The data transmission may be performed by wireless or by wires.

The sub storage device A21 and the relay storage device A322 may include use time storage devices A212 and A3222 that are configured to record a time of use of the unavailable currency. In this case, as the sub storage device A21 and the relay storage device A322 check and compare states of an execution result of a process of exchange to a value in the available currency based on an exchange rate at an update time and the unavailable currency at a use time, it is possible to easily determine whether the execution result of the process is appropriate.

The exchange rate management system P1 may include a main update device A311 including an input device accepting an input from an operator in order to update an exchange rate stored in the main storage device A312, a relay update device A321 including an input device accepting an input from an operator in order to update an exchange rate stored in the relay storage device A322, and a deployment device A323 including an input device accepting an input from an operator in order to deploy, in the sub storage device A21, an exchange rate stored in the relay storage device A322. With this arrangement, it is possible to update a stored exchange rate and deploy the exchange rate in each processing unit P2, under visual control from the outside by which massive falsification of the exchange rate in a short time is prevented.

The exchange rate management system P1 described above may be arranged so that the main storage device A312 is provided in an exchange rate management device A31, the relay storage device A322 is provided in a relay device A32, and the exchange rate management device A31 and the relay device A32 are provided in a process management device P3. The exchange rate management system P1 arranged in this manner can be organized into the processing units P2, the exchange rate output device A4 configured to output an exchange rate, and the process management device P3 having the functions of the exchange rate management device A31 and the relay device A32. To put it differently, the exchange rate management device A31 and the relay device A32 can be embodied by software executable by the process management device P3 which is an information processor.

(Specific Example of Exchange Rate Management System: Game System)

The following will describe an exchange rate management system P1 when a processing unit P2 is a gaming machine A2. In this case, the exchange rate management system P1 may be regarded as a game system A1, and the process management device P3 may be regarded as a game management device A3.

To be more specific, the game system A1 which is the exchange rate management system P1 includes gaming machines A2 in which game play is possible with a value in an available currency exchanged from a value in an unavailable currency at an exchange rate, a main storage device A312 configured to store an exchange rate updated at a predetermined timing, a sub storage device A21 which is provided in each gaming machine A2 to store an exchange rate, and a relay storage device A322 configured to store an exchange rate which is to be deployed in the sub storage device A21, in a manner of being updatable to the exchange rate stored in the main storage device A312. The main storage device A312, the sub storage device A21, and the relay storage device A322 include update time storage units A3121, A211, and A3221 each of which stores a time when an exchange rate is updated.

In the game system A1 arranged as described above, because an update time of the exchange rate is stored in all of the main storage device A312, the sub storage device A21, and the relay storage device A322, it is possible to easily check the update state of the exchange rate in each of the storage devices A312, A21, and A322 based on the update time and the exchange rate. On this account, even when exchange is performed at a wrong exchange rate, it is possible to easily correct the wrong state to a state in which the exchange is performed at a correct exchange rate.

(Game System: Casino System)

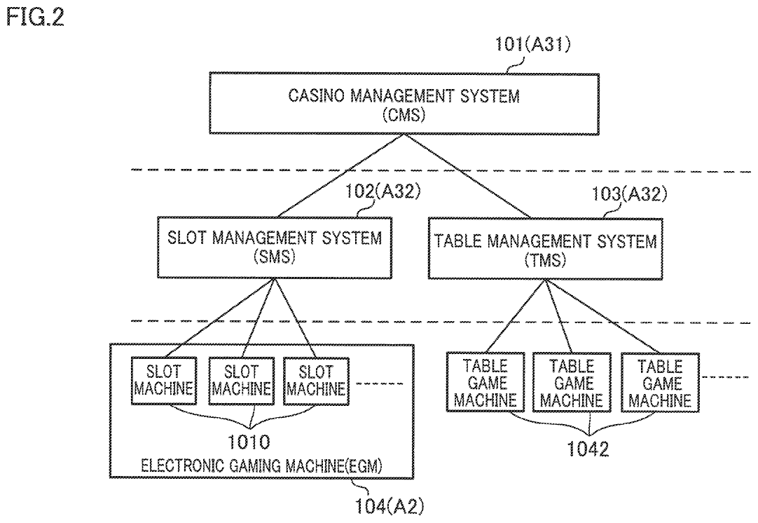

FIG. 2 shows a case where the game system A1 is applied to a casino system. The casino system is a system in which electronic gaming machines (EGM) 104 that are gaming machines A2 shown in FIG. 1 are managed in two management layers.

To be more specific, the electronic gaming machines 104 of the casino system include slot machines 1010 and table game machines 1042 that are electronic gaming machines 104. A slot game is playable at each slot machine 1010, and an exchange rate is displayable at a PTS terminal. Meanwhile, table games such as baccarat and roulette are playable at each table game machine 1042. In the casino system, safety of foreign currencies in the electronic gaming machines 104 is secured by four management divisions. The four divisions are a game technology service (GTS) division, an electronic game organization (EGO) division, a cage and count division, and a gaming audit division.

In the casino system, a casino management system (CMS) 101 having the functions of the exchange rate management device A31 shown in FIG. 1 is provided in the upper management layer, whereas a slot management system (SMS) 102 and a table management system (TMS) 103 having the functions of the relay device A32 shown in FIG. 1 are provided in the lower management layer. With this arrangement, in the casino system, an exchange rate stored in the casino management system 101 is deployable in the gaming machines A2 through the slot management system 102, and an update time of an exchange rate can be recorded in the casino management system 101, the slot management system 102, and the gaming machines A2.

The casino management system 101 has a function of adding up and managing the sales at the slot machines 1010 and the table game machines 1042. Furthermore, the casino management system 101 has a function of recording an exchange rate and an update time of the exchange rate in an exchange rate recording table.

In the casino management system 101, a person who is a cage shift manager or superior is designated as a person with authority of maintenance, and this person maintains the exchange rate daily. In the casino management system 101, furthermore, a person who is a cage shift manager or superior is designated as a person with authority of check, and this person integrates an exchange rate daily and checks if a correct exchange rate is stored in the slot management system 102 and the table management system 103 in the lower management layer. In the casino management system 101, furthermore, an exchange rate is displayed on a foreign exchange rate display board in the cage and count division.

The slot management system 102 in the lower management layer has a function of adding up the sales at the slot machines 1010. The slot management system 102 may have a function of recording an exchange rate and an update time of the exchange rate in an exchange rate recording table. With this function, the slot management system 102 is able to manage an exchange rate and an update time at a slot machine 1010 when only the slot machine 1010 is provided, i.e., when the slot machine 1010 is not provided with a PTS terminal.

The table management system 103 provided in the same management layer as the slot management system 102 has a function of adding up the sales at the table game machines 1042. The table management system 103 may have a function of recording an exchange rate and an update time of the exchange rate in an exchange rate recording table. With this function, the table management system 103 is able to manage the exchange rate and the update time of each table game machine 1042.

In the slot management system 102 and the table management system 103, a certified officer of the GTS division, who is an administrator or superior, maintains a currency setting and at least one of a game area or an electronic gaming machine 104, which are capable of accepting an unavailable currency different from an available currency that is a basic currency. The slot management system 102 then sends the currency setting to a PTS terminal 1700 and sets the currency setting therein, and causes the PTS terminal 1700 to determine whether the money type and the monetary amount are available ones and determine whether a currency is the available currency (domestic currency) or the unavailable currency (foreign currency).

For example, when an available currency that is a basic currency is Philippine Peso, a game area or an electronic gaming machine 104 where U.S. Dollar, Hong Kong Dollar, Japanese Yen, and so on can be used as unavailable currencies is set. In this way, the PTS terminal 1700 in which the currency setting has been performed by the slot management system 102 is able to manage the unavailable currencies used in an electronic gaming machine 104 by determining whether a banknote is that of the available currency.

In the slot management system 102 and the table management system 103, a certified officer of the EGO division, who is an administrator or superior, is designated as a person with authority of check, and the person checks a currency setting and at least one of a game area or an electronic gaming machine 104, which are capable of accepting an unavailable currency different from an available currency that is a basic currency. In the slot management system 102 an the table management system 103, a certified officer of the EGO division manages and administrates the exchange rate.

In addition to the above, a certified officer of a gaming audit division, who is a gaming auditor or superior, is set as a person with authority of check, and this person executes a gaming audit process to ensure that all transactions of banknotes (of a currency or currencies) are correctly reported in the slot management system 102 and the table management system 103.

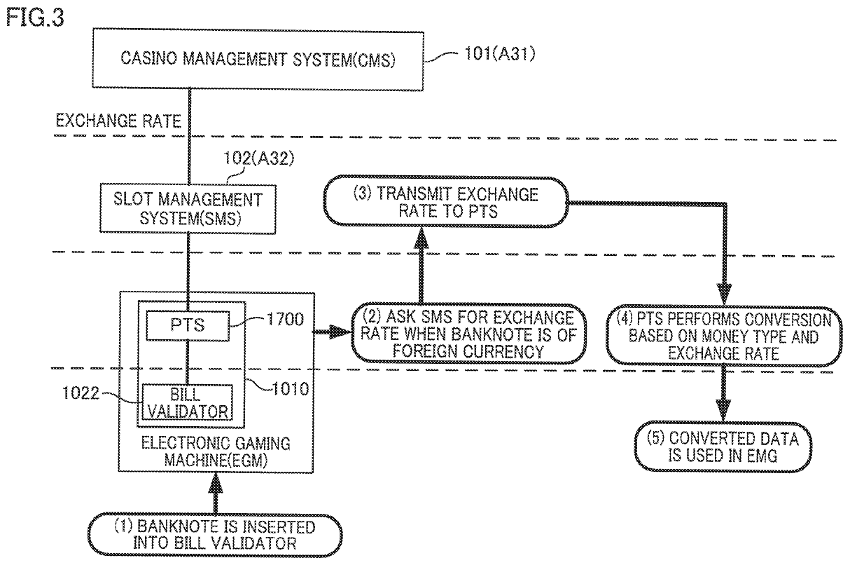

As shown in FIG. 3, when the casino system arranged as described above includes a slot machine 1010 having a PTS terminal 1700, the PTS terminal 1700 performs exchange based on a money type and an exchange rate. To be more specific, a banknote is inserted into a bill validator of an electronic gaming machine 104 and the banknote is identified and verified. If the banknote is a valid banknote, an identification result indicating the money type and monetary amount of the banknote is transmitted to the PTS terminal 1700. The PTS terminal 1700 determines whether the money type and the monetary amount are available ones and determine whether the currency is the available currency (domestic currency) or the unavailable currency (foreign currency).

When it is determined that the currency is the available currency, the PTS terminal 1700 sets the banknote inserted into the bill validator 1022 to be usable in the electronic gaming machine 104. When it is determined that the banknote is not usable, the PTS terminal 1700 causes the banknote inserted into the bill validator 1022 to be discharged and returned to a player. When it is determined that the currency is the unavailable currency, the PTS terminal 1700 requests the slot management system 102 to send an exchange rate.

A request signal requesting an exchange rate is sent from the PTS terminal 1700 to the slot management system 102. The slot management system 102 sends an exchange rate corresponding to the money type to the PTS terminal 1700. The PTS terminal 1700 allows an unavailable currency to be usable in an electronic gaming machine 104 by performing processes of exchanging the unavailable currency to the available currency based on the money type and the exchange rate and sending data after the exchange to a gaming controller of the electronic gaming machine 104.

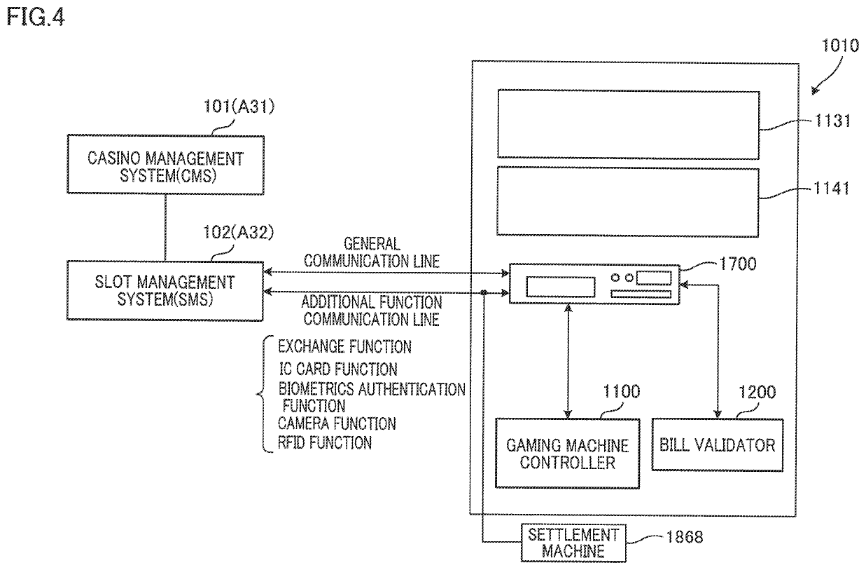

(Game System: Casino System: Slot Machine 1010) FIG. 4 shows a case where a slot machine 1010 is employed as an electronic gaming machine 104 in the casino system arranged as described above. The slot machine 1010 is connected to the casino management system 101 so that data communication is possible therebetween. The slot machine 1010 includes a PTS terminal 1700 which is a sub storage device A21. The PTS terminal 1700 is configured to authenticate a player by a player authentication unit (a human detection camera, a microphone, and/or a human detection sensor). In addition to the compatibility with existing systems thanks to a known system communication capability, the PTS terminal 1700 has a communication line that is an additional function. It is therefore possible in the PTS terminal 1700 to add information regarding authentication and information regarding exchange by means of a dedicated line.

Furthermore, the PTS terminal 1700 updates the exchange rate transmitted from the casino management system 101 through the slot management system 102, records the update time, and displays the exchange rate. The update of the exchange rate and the recording of the update time may be performed only when the PTS terminal 1700 is prohibited to accept foreign currencies.

The bill validator 1022 identifies and verifies the banknote. If the banknote is invalid as a result of the verification, the bill validator 1022 discharges the banknote. If the banknote is valid as a result of the verification, the bill validator 1022 outputs a result of identification of the money type (currency type) and the monetary amount of the banknote to the PTS terminal 1700. When the identification result from the bill validator 1022 indicates that the banknote is that of the available currency, the PTS terminal 1700 outputs the monetary amount indicated by the identification result to a gaming machine controller 1100 and proceeds with a slot game. Meanwhile, when the identification result indicates that the banknote is that of an unavailable currency, the PTS terminal 1700 asks the slot management system 102 for sending an exchange rate corresponding to the unavailable currency, obtains the exchange rate corresponding to the unavailable currency from the slot management system 102, and exchanges the money type data and the monetary amount data to a value in the available currency based on the exchange rate.

For example, when a PTS terminal 1700 (slot machine 1010) is provided in the U.S.A., the PTS terminal 1700 exchanges a Japanese banknote inserted into a bill validator 1022 to the U.S. currency based on an exchange rate in the casino management system 101. After-exchange currency value data indicating a monetary value after the exchange is then sent to the gaming machine controller 1100. The player is therefore able to play games at the slot machine 1010 by using a currency different from the U.S. currency.

(Game System: Casino System: Setting—Process of Updating Exchange Rate)

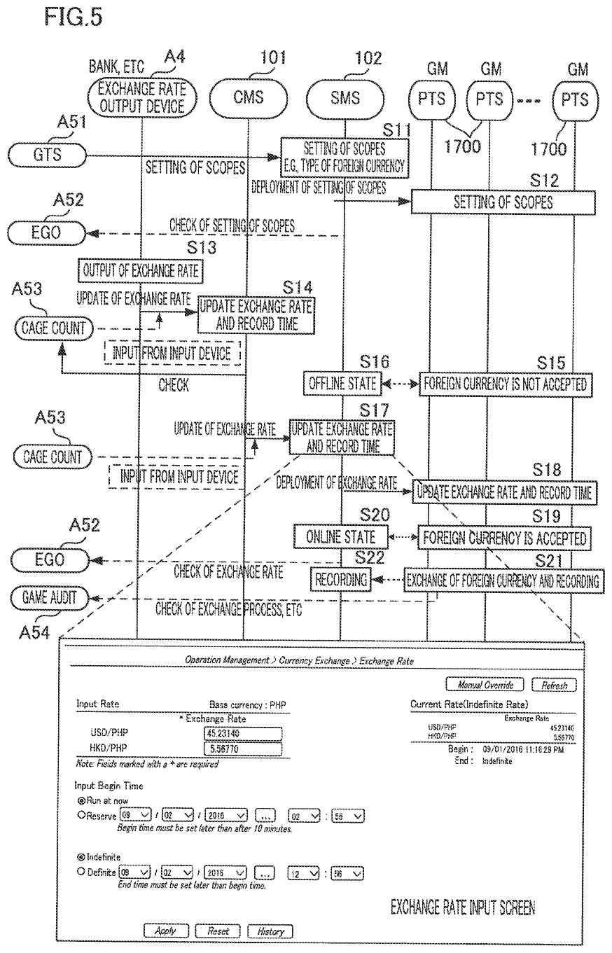

As shown in FIG. 5, in the casino system, currencies are managed by an organization that is divided into a GTS (game technology service) division A51, an EGO (electronic game organization) division A52, a cage and count division A53, and a gaming audit division A54.

When the scopes and limits of currencies are authorized by an upper manager, the authorized settings are sent to all divisions A51, A52, A53, and A54. The scopes indicate ranges of authorization regarding the types of currencies, game fields, and acceptance of plural currencies at gaming machines A2.

Thereafter, the GTS division A51 sets the authorized scopes in the slot management system 102. The setting of the scopes is sent from the slot management system 102 to, for example, the PTS terminal 1700 of each gaming machine A2. The setting of the scopes is authorized by the EGO division A52. A setting history log is sent to the cage and count division A53 and the game audit division A54.

When an exchange rate is output from an exchange rate output device A4 of a bank at a timing during a predetermined period from 10 a.m. to 12 p.m. on a bank business day (S13), the exchange rate is updated for the casino management system 101 by an operator of the cage and count division A53 by using an input device. At this stage, the casino management system 101 updates the exchange rate and records the update time (S14).

After the exchange rate is updated, the PTS terminal 1700 becomes a state of not accepting foreign currencies (S15), and when the slot management system 102 is switched to an offline state (S16), an operator of the cage and count division A53 makes an input to the slot management system 102 (relay device A32) by using an input device, based on the exchange rate displayed on the casino management system 101 (exchange rate management device A31). In the gaming machine (slot machine), a game with the available currency is executable even when the PTS terminal 1700 cannot accept foreign currencies.

The slot management system 102 (relay device A32) to which the exchange rate is input updates the exchange rate and records the update time. To be more specific, an exchange rate input screen is displayed. In the exchange rate input screen, input columns for exchange rates are displayed to correspond to an available currency and an unavailable currency set in advance by the setting of scopes. For example, when the available currency is Philippine Peso and the unavailable currencies are U.S. Dollar and Hong Kong Dollar, a USD/PHP column and an HKD/PHP column are automatically displayed and input columns for exchange rates corresponding to these columns are automatically displayed. Furthermore, an input start time column and an input end time column for the exchange rate are displayed.

When an exchange rate is input to each of the USD/PHP column and the HKD/PHP column, an input start time is input to the input start time column, and an input end time is input to the input end time column, the exchange rates are transmitted to (deployed in) the PTS terminal 1700 of the corresponding gaming machine A2. In response to this, the PTS terminal 1700 updates the exchange rates, record the update time, and displays the exchange rates (S18).

Thereafter, when the PTS terminal 1700 is switched to a state of accepting foreign currencies (S19) and the slot management system 102 is switched to an online state (S20), an operator of the EGO division A52 checks the exchange rates in the slot management system 102. When U.S. Dollar or Hong Kong Dollar that is a foreign currency (unavailable currency) is exchanged to Philippine Peso that is an available currency at the exchange rate in the PTS terminal 1700 (S21), the data of this foreign currency exchange and the exchange time is transmitted to and recorded in the slot management system 102, and is recorded also in the PTS terminal 1700 (S22). The process of foreign currency exchange is reviewed by the game audit division A54.

(Game System: Casino System: Processing Steps: Rate Calculation)

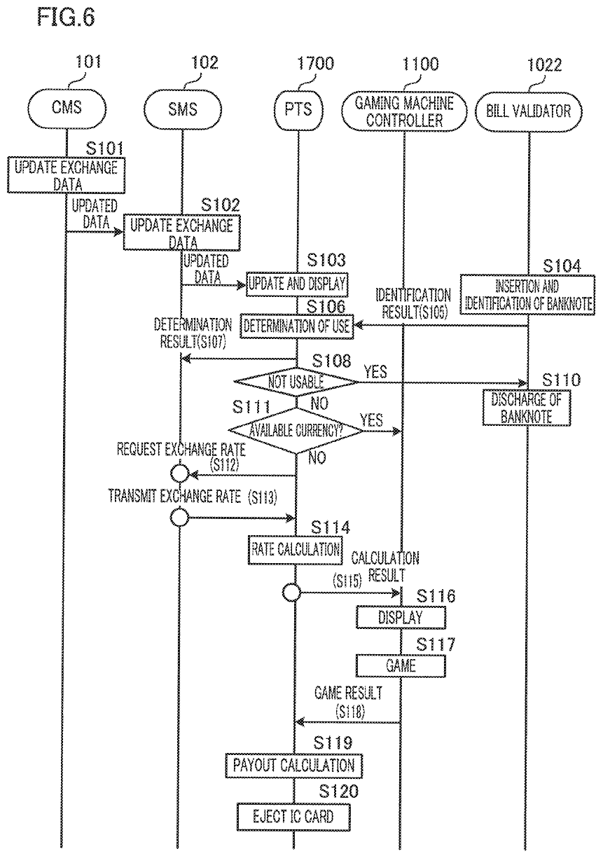

FIG. 6 shows steps after sets of exchange data stored in memories of the casino management system 101 (exchange rate management device A31), the slot management system 102 (relay device A32), and the PTS terminal 1700 (sub storage device A21) are updated in the steps of updating the exchange rates shown in FIG. 5 (in S101, S102, and S103).

To be more specific, when a banknote is inserted into the bill validator 1022 and the money type and monetary amount are specified (S104), an identification result constituted by money type data and monetary amount data is transmitted to the PTS terminal 1700 if the inserted banknote is a valid banknote as a result of verification (S105). Upon receiving the identification result from the bill validator 1022, the PTS terminal 1700 performs a use determination process based on the identification result.

To be more specific, based on the identification result, the PTS terminal 1700 determines whether the banknote inserted into the bill validator 1022 is of an available money type and an available monetary amount and determines whether the money type is an available currency or an unavailable currency (S106), and sends the determination result to the slot management system 102 (S107).

When the determination result indicates that the banknote is unusable (YES in S108), the PTS terminal 1700 transmits an unusable signal to the bill validator 1022 and discharges the inserted banknote from the bill validator 1022 (S110). Meanwhile, if the banknote is usable (NO in S108), then whether the determination result indicates that the currency of the banknote is the available currency is determined (S111). If the determination result indicates that the currency of the banknote is the available currency (YES in S111), the monetary amount data in the identification result is converted to credit data used for a game and then output to the gaming machine controller 1100. As a result of this, it becomes possible to play the game with the banknote inserted into the bill validator 1022.

Meanwhile, when the determination result indicates that the currency of the banknote is the unavailable currency (NO in S111), an exchange rate request signal is transmitted to the slot management system 102 (S112). The slot management system 102 sends an exchange rate corresponding to the money type to the PTS terminal 1700 that is the sender of the exchange rate request signal (S113). For the purpose of reducing the communication load, the steps S112 and S113 may not be performed and an exchange rate updated in advance (S18) may be used.

The PTS terminal 1700 calculates a rate for conversion to monetary amount data in the local currency that is the available currency, based on the received exchange rate (S114). The PTS terminal 1700 then further converts the monetary amount data in the local currency obtained as a result of the rate calculation into credit data for the game. Thereafter, the credit data is transmitted to the gaming machine controller 1100 as a calculation result (S115).

The gaming machine controller 1100 displays the calculation result on a display unit of the slot machine 1010 (S116) and executes the game based on the monetary amount that is the result of the exchange to the local currency (S117). A game result is transmitted from the gaming machine controller 1100 to the PTS terminal 1700 (S118), and the PTS terminal 1700 calculates a payout based on the game result (S119) and determines a monetary amount paid out to the player. The PTS terminal 1700 writes the determined monetary amount data in the local currency into an IC card, and ejects the IC card (S120). When an IC card storing monetary amount data has been inserted into the PTS terminal 1700, the monetary amount data of this inserted IC card is updated by adding monetary amount data obtained as a result of the game.

(Modifications)

In the present embodiment, each time the unavailable currency is used in the gaming machine A2, the exchange rate stored in the relay storage device A322, i.e., the exchange rate in the slot management system 102 is referred to for the purpose of conversion to a value in the available currency. However, the disclosure is not limited to this arrangement. For example, each time the unavailable currency is used in the gaming machine A2, an exchange rate stored in the sub storage device A21, i.e., an exchange rate in the PTS terminal 1700 may be referred to for the purpose of conversion to a value in the available currency.

While in the embodiment above the use determination process is executed by the PTS terminal 1700 based on the identification result from the bill validator 1022, the disclosure is not limited to this arrangement. For example, the use determination process may be executed in the slot management system 102, and the determination result may be transmitted to the PTS terminal 1700 and used for determination of whether a banknote is usable (S108) and determination of an available currency (S111).

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

### REFERENCE SIGNS LIST

P1 exchange rate management system
P2 processing unit
P3 process management device
A1 game system
A2 gaming machine
A3 game management device
A4 exchange rate output device
A21 sub storage device
A31 exchange rate management device
A32 relay device
A211 sub storage device
A212 use time storage device
A311 main update device
A312 main storage device

1. An exchange rate management system including processing units that are capable of converting a value in an unavailable currency to a value in an available currency at an exchange rate and processing the value, the exchange rate management system comprising:
a main storage device configured to store the exchange rate which is updated at a predetermined timing;
a sub storage device which is provided in each of the processing units to store the exchange rate; and
a relay storage device configured to store an exchange rate to be deployed in the sub storage device, in a manner of being updatable to the exchange rate stored in the main storage device,
each of the main storage device, the sub storage device, and the relay storage device including an update time storage unit configured to record a time when the exchange rate is updated.

2. The exchange rate management system according to claim 1, wherein, each of the sub storage device and the relay storage device further includes a use time storage device configured to record a time when the unavailable currency is used.

3. The exchange rate management system according to claim 1, further comprising:
a main update device which includes an input device accepting an input from an operator in order to update the exchange rate stored in the main storage device;
a relay update device which includes an input device accepting an input from an operator in order to update the exchange rate stored in the relay storage device; and
a deployment device which includes an input device accepting an input from an operator in order to deploy, in the sub storage device, the exchange rate stored in the relay storage device.

4. A game system including gaming machines in which a game is playable by converting a value in an unavailable currency to a value in an available currency at an exchange rate, the game system comprising:
a main storage device configured to store the exchange rate which is updated at a predetermined timing;
a sub storage device which is provided in each of the gaming machines to store the exchange rate; and
a relay storage device configured to store an exchange rate to be deployed in the sub storage device, in a manner of being updatable to the exchange rate stored in the main storage device,
each of the main storage device, the sub storage device, and the relay storage device including an update time storage unit configured to record a time when the exchange rate is updated.

5. A game system including gaming machines in which a game is playable by converting a value in an unavailable currency to a value in an available currency at an exchange rate, the game system comprising:
a main storage device configured to store the exchange rate which is updated at a predetermined timing;
a sub storage device which is provided in each of the gaming machines to store an exchange rate that is referred to each time the unavailable currency is used in one of the gaming machines; and
a relay storage device configured to store an exchange rate to be deployed in the sub storage device, in a manner of being updatable to the exchange rate stored in the main storage device,
each of the main storage device, the sub storage device, and the relay storage device including an update time storage unit configured to record a time when the exchange rate is updated.
